(19) United States
(12) Patent Application Publication
(10) Pub. No.: US 2011/0118014 A1
(43) Pub. Date: May 19, 2011

(54) GAMING DEVICE HAVING A TOP BOX WITH A RECONFIGURABLE POINTER

(75) Inventors: Michael J. Mitchell, Las Vegas, NV (US); William R. Wadleigh, Henderson, NV (US); Karl E. Wudtke, Las Vegas, NV (US); Vernon H. Bernard, II, Henderson, NV (US)

(73) Assignee: BALLY GAMING, INC., Las Vegas, NV (US)

(21) Appl. No.: 12/619,631

(22) Filed: Nov. 16, 2009

(51) Int. Cl. A63F 13/00; A63F 9/24

(52) U.S. Cl. 463/30; 463/25

(57) ABSTRACT

Various embodiments are directed to gaming machines with a top box having a reconfigurable pointer. The reconfigurable pointer identifies a particular game outcome and is alterable for different games. According to one embodiment, the gaming machine includes a first display located within a main cabinet for presenting a main game, and a second display located in a top box for presenting a second game. In one embodiment, the main cabinet also includes a virtual button deck for controlling the main game and the second game.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Over the years, gaming machines have grown in both sophistication and gaming features to maintain player interest. Gaming machines have gone from relatively simple devices providing a player with an opportunity to win cash awards to sophisticated, multi-media devices. Even more, the games presented on the gaming machines have become increasingly intricate. For example, slot-style games may include five or more reels with twenty or more paylines. Furthermore, games may include one or more bonus games or different game modes that allow a player to participate in a community game or a tournament. Accordingly, with the increasing complexity of these games, there is a continuing need for gaming machines to have the capabilities to support these games.

### SUMMARY

Briefly, and in general terms, various embodiments are directed to gaming machines with a top box having a reconfigurable pointer. The reconfigurable pointer identifies a particular game outcome and is alterable for different games.

According to one embodiment, the gaming device includes: a main display for presenting a primary game. The gaming device also has a top box having a video display. The video display presents a secondary game when a triggering event has been established during play of the primary game. The gaming device also includes one or more reconfigurable pointers positioned on the top box. The reconfigurable pointers may identify an outcome of the secondary game. The gaming machine also includes a touch glass producing touch data when activated in which the touch data initiates play of the secondary game.

In addition to gaming devices, methods for presenting a bonus game in a top box having a video display and one or more reconfigurable pointers are disclosed herein. One method for presenting a bonus game includes: receiving player input initiating play of a game on a gaming device; determining whether a trigger event is established during play of the game; configuring one or more reconfigurable pointers in response to the trigger event being established; displaying the bonus game on the video display in response to the trigger event being established; receiving touch data from the player after the trigger event is established, wherein the touch data initiates play of the bonus game; and identifying an outcome of the bonus game with one or more of the reconfigurable pointers.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of one embodiment of a gaming device.

FIG. 1A is a perspective view of one embodiment of a top box having reconfigurable pointers.

FIG. 1B is a perspective view of yet another embodiment of a top box having reconfigurable pointers.

FIG. 1C is a front view of another embodiment of a top box having a reconfigurable pointer.

FIG. 2 is one embodiment of an exploded perspective view of the touch panel system that may be incorporated into one or more displays of the gaming device of FIG. 1.

FIG. 3 is an operational flow diagram of a gaming device having a touch panel system.

FIG. 4 is an operational flow diagram of a gaming device having a touch panel system.

FIGS. 5A-5B are screen shots of one embodiment of a secondary game presented on a top box of the gaming device of FIG. 1.

FIGS. 6A-6B is a screen shot of another embodiment of a secondary game presented on a top box of the gaming device of FIG. 1.

FIG. 7 is a screen shot of one embodiment of a touch screen display that may be used with the secondary game shown in FIGS. 6A-6B.

FIG. 8 is a screen shot of yet another embodiment of a secondary game presented on a top box of the gaming device of FIG. 1.

FIG. 9 illustrates a block diagram of one embodiment of the internal components of a gaming device.

FIG. 10 illustrates one embodiment of a gaming system network including the gaming devices of FIG. 1.

### DETAILED DESCRIPTION

Various embodiments are directed to gaming machines with a top box having a reconfigurable pointer. The reconfigurable pointer identifies a particular game outcome and is alterable for different games. According to one embodiment, the gaming machine includes a first display located within a main cabinet for presenting a main game, and a second display located in a top box for presenting a second game. In one embodiment, the main cabinet also includes a virtual button deck for controlling the main game and the second game.

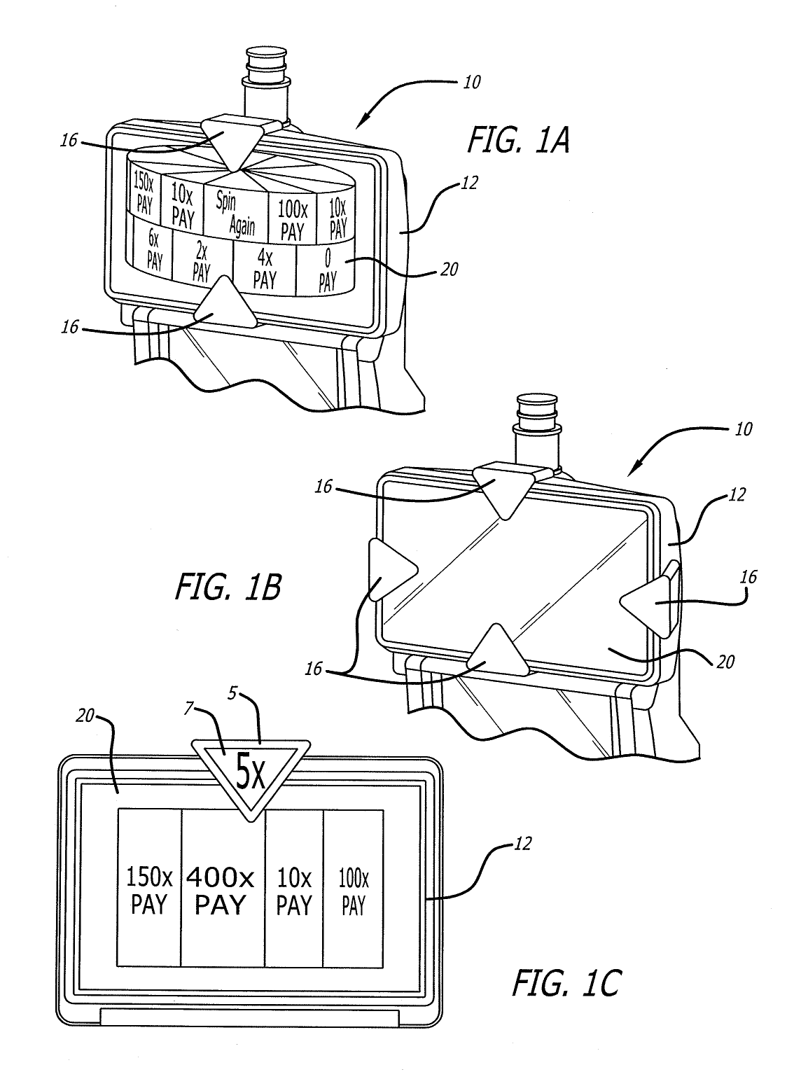

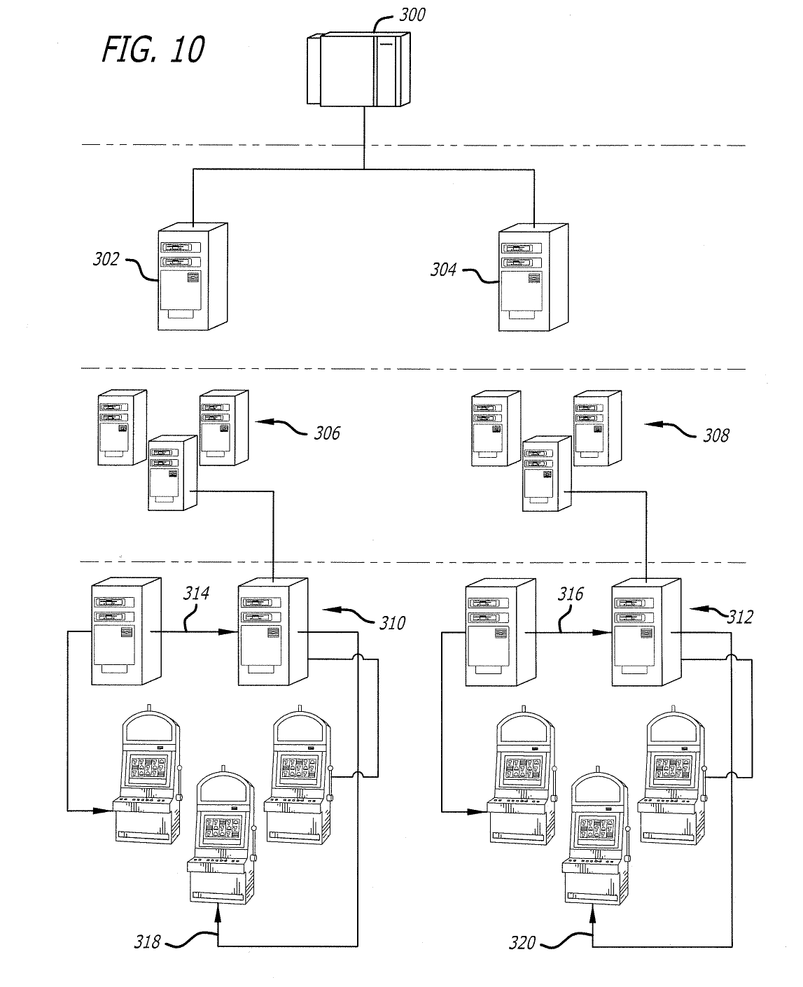

Referring now to the drawings, wherein like reference numerals denote like or corresponding parts throughout the drawings and, more particularly to FIGS. 1-10, there are shown various embodiments of a gaming device with a top box having a reconfigurable pointer. More specifically, as shown in FIG. 1, the gaming machine 10 includes a top box 12 and a main cabinet 14. According to one embodiment, the top box 12 is a separate and distinct component that is affixed to the main cabinet 14. In another embodiment, the top box 12 is an area that is partitioned from the main cabinet 14. Alternatively, the top box 12 and the main cabinet 14 may be contiguous areas with the outward appearance of two distinct components.

As shown in FIG. 1, a reconfigurable pointer 16 is positioned at the top of the top box 12. The reconfigurable pointer 16 is a physical device that is backlit with one or more light bulbs, light emitting diodes (LEDs), fluorescent bulbs, cold cathode tubes, video displays, or any illumination source known or developed in the art. As shown in FIG. 1, the reconfigurable pointer 16 is generally triangular in shape. In other embodiments, the reconfigurable pointer (not shown) may have any shape known or developed in the art so long as the pointer functions to identify a particular outcome and/or outcomes.

FIG. 1 illustrates the top box 12 as having a single reconfigurable pointer 16. In other embodiments, there may be more than one reconfigurable pointer. For example, FIG. 1A illustrates an embodiment of a top box 12 having reconfigurable pointers 16 positioned on opposites of the top box. In another embodiment, the reconfigurable pointers (not shown) may be positioned on adjacent sides of the top box 12. In one embodiment, one or more reconfigurable pointers (not shown) may be positioned on the same side of the top box 12. In yet another embodiment, the reconfigurable pointers 16 may be positioned on every side of the top box 12 as shown in FIG. 1B.

In the embodiments having more than one reconfigurable pointer 16, one or more of the pointers may be active during play of the secondary game. The active pointer may be randomly selected by the gaming machine or the player may select an active pointer. In other embodiments, player performance, such as, but not limited to, rate of play or duration of play may dictate whether one or more of the pointers 16 are active. As discussed below, various trigger events may be used to determine the number of reconfigurable pointers 16 that are active during a main game or a secondary game. In another embodiment, the selection of one or more active reconfigurable pointers 16 may occur prior to and/or during play of the primary game or the secondary game.

Depending on the status of the main game and/or the secondary game, the color, intensity, or duration (e.g., flashing or steady state) of the reconfigurable pointer 16 may be reconfigured. By way of example, and not of limitation, the reconfigurable pointer 16 may change colors, intensity, or duration depending upon a secondary (e.g., bonus) game being presented to a player. In another embodiment, the pointers 16 may be illuminated or otherwise active during an attract mode of the game.

In one embodiment, the reconfigurable pointer 5 is a video display 7. The video display may be an electroluminescent display, an organic light emitting diode (OLED) display, an electronic paper (e-paper) display, a LCD display, a video display incorporating Rosco film, an array of LEDs, or any combination thereof. As shown in FIG. 1C, for example, the video display 7 presents a multiplier symbol when the secondary game is completed. In other embodiments, the video display 7 may present a wild symbol, free spin symbol, or any other images, video clips, or animation. The video display 7 may present these various images before, during, and after play of the primary and/or secondary game.

Optionally, as shown in FIG. 1, the top box 12 includes a lighted bezel 18 around the perimeter of the top box. The color, intensity, or duration (e.g., flashing or steady state) of the bezel 18 may be the same as the reconfigurable pointer 16 in order to provide a unified presentation to a player. In another embodiment, the top box (not shown) having a reconfigurable pointer does not include a lighted bezel.

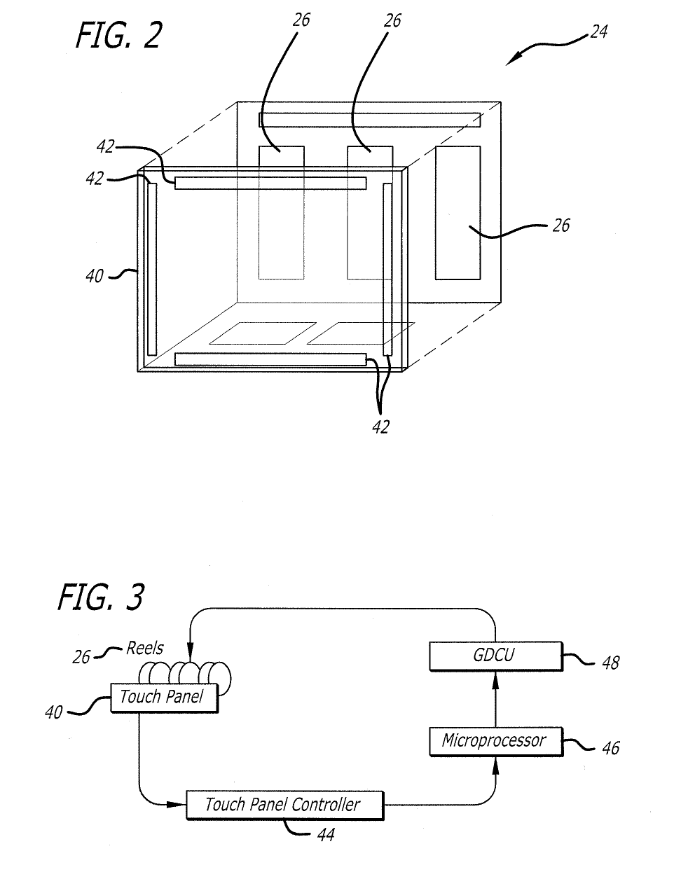

The top box 12 also includes a video screen 20. In a first mode or configuration, the video display 20 may present the name of the game, pay table, other game information, tournament game information, or non-game related information (e.g., news, advertisements, or promotions). In a second configuration, the video screen 20 may present one or more bonus games in response to a triggering event. Additionally, in some embodiments, the video screen 20 may also present a pay line or other indicator in combination with the reconfigurable pointer 16 to identify a winning outcome for a bonus game. Optionally, the video screen 20 may also include a touch screen or touch glass system 36, as shown in FIGS. 2-4. The touch screen system 36 allows a player to input choices without using any electromechanical buttons. Alternatively, the touch screen system 36 may be a supplement to the electromechanical buttons. In one embodiment, the touch screen is a transparent, flat surface that is spaced apart from the video display 20, as disclosed in U.S. patent application Ser. No. 11/209,895, filed Aug. 21, 2005, which is hereby incorporated by reference.

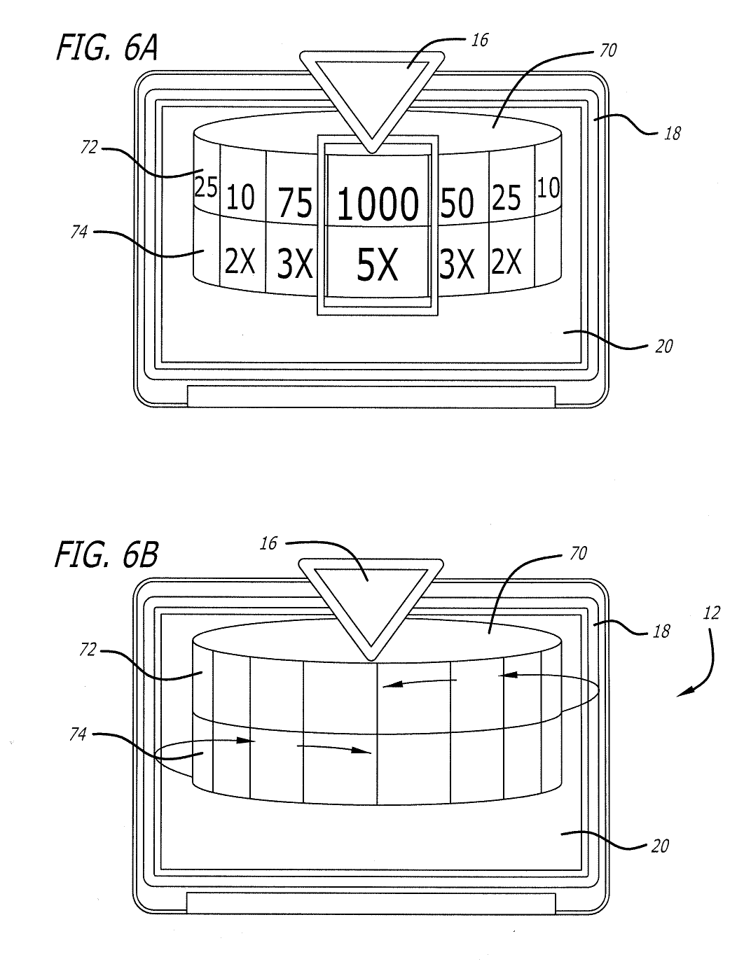

FIGS. 2-4 illustrate one embodiment of a touch sensor assembly 42 incorporating a substantially transparent touch panel 40, a touch controller 44, and touch panel software. As shown in FIG. 6, the touch panel 40 utilizes the touch sensor assembly 42 to produce touch data when touched or activated, as well as allowing substantially unobstructed viewing of the projected images of the reels 26 shown on a display 20, 24 behind the touch panel. The touch sensor assembly 42 includes one or more touch pad areas (not shown), one or more touch transducers 38, wave reflectors (not shown), cabling (not shown), a bezel (not shown), a touch panel controller 44, touch panel driver software, and touch panel application software. The material for the touch pad areas (not shown), is either glass or other polymeric material suitable for propagating surface acoustic waves.

As shown in FIG. 3, the touch panel 40 is placed in front the projected images of the reels 26. Touch panel data received by the touch panel 40 is transmitted to the touch panel controller. The touch panel controller 70 acts to control and interpret touch data from the touch panel 40. The controller 44 typically includes a printed circuit board assembly, often encased inside a metal or plastic housing with mounting holes. In one embodiment, the controller 44 is mounted to the inside of the gaming machine door or cabinet, and is preferably within reach of the touch panel wiring (not shown). The controller 44 is wired to the appropriate power and communication connections within the gaming machine. The controller 44 outputs a data stream consisting of touch coordinate information.

In one embodiment, the microprocessor 46 runs an application that translates the touch panel controller 44 serial touch information into reel control commands for the GDCU reel controller 48. The application uses drivers to communicate with the GDCU 48 which controls the projection of the image onto the curved display 12. The GDCU 48 is a communications portion of the gaming machine 10 which “talks” to the different components of the gaming machine.

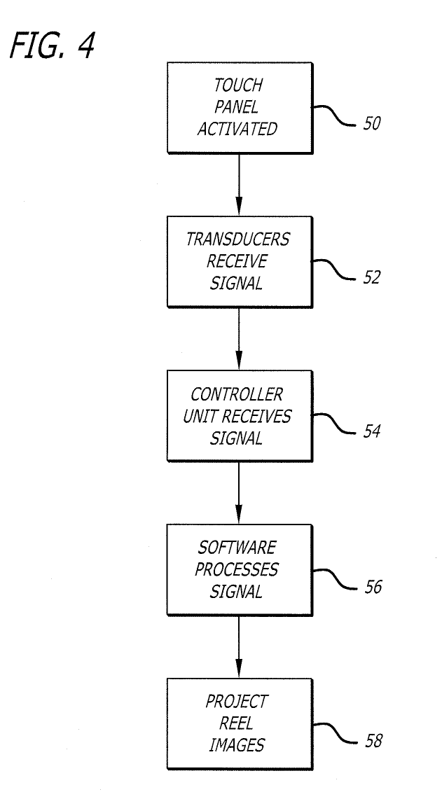

FIG. 4 illustrates the operational flow of a gaming machine 10 including a touch panel system. As shown in FIG. 4, the logical operations of the various embodiments of the touch screen system are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the touch panel system. Accordingly, the logical operations making up the embodiments of the touch panel system described herein, are referred to variously as operations, structural devices, acts or modules. It will be recognized by one skilled in the art that these operations, structural devices, acts and modules may be implemented in the system, in firmware, in special purpose logic, analog circuitry, or any combination thereof.

As shown in FIG. 4, the logical operations of a touch panel system 36 utilize the components of the system in a logical sequence. In the panel activation step 58, the touch panel 40 is activated. This occurrence produces a signal that is received by the transducers 38 associated with the touch panel 40 in the transducer signaling step 52. In the controller signaling step 54, a signal is sent to the touch panel controller 44 reporting the activation of the touch panel 40. From the touch panel controller 44, a signal is then sent to, and interpreted by, the touch panel software (which is in the microprocessor 46) in the signal processing step 56. Finally, the touch panel software sends a signal to the GDCU reel controller 48 to spin the reel images 26 at step 58.

The touch panel system 36 is adapted to detect and interpret different types of touch data. For example, in one embodiment, the touch data in the form of a touch gesture generally parallel to the reels will cause the image of the reels to spin. The touch gesture in a “slide up” or “slide down” motion will initiate the spinning of the reels. The gesture causes the reels to spin in the particular direction of the gesture. For example, if the gesture moves top-down on the touch screen, the reels spin in a top-down direction. Alternatively, if the gesture moves bottom-up on the touch screen, the reels spin in a bottom-up direction. Additionally, the speed of the gesture may effect the speed of the spinning of the reels. For example, if the gesture is fast, the reels spin fast whereas the reels will spin slower for a slower gesture. Generally, any gesture on the touch screen that is parallel to the image of the reels will cause all the reels to spin. In another embodiment, the player needs to make a gesture at a particular area adjacent to the image of the reels in order to cause the image of the reels to spin. In yet another embodiment, the player can gesture to control each reel. Accordingly, the player may vary the order and/or speed of each reel spun.

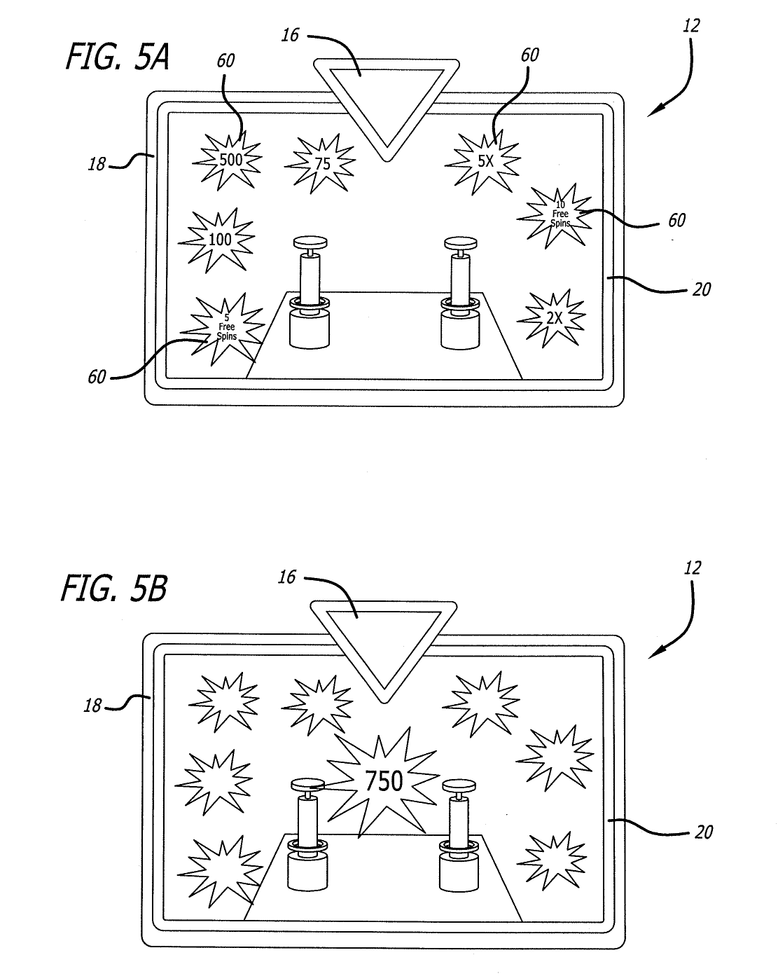

FIGS. 5, 6 and 8 illustrate embodiments of a secondary game that may be presented in response to a triggering event. The triggering event is a condition that needs to be satisfied in order to initiate play of a secondary game on the video display 20 of the top box 14. According to one embodiment, the triggering event is a computer or system generated response such as, but not limited to, a message from a system host, a message from another networked gaming machine, or a winning outcome in a primary game. For example, the triggering event may be a symbol combination of “cherry-cherry-cherry” for a slots-type game. In another embodiment, the triggering event is one or more bonus symbols located on one or more reels. By way of example, and not of limitation, a triggering event is three or more bonus symbols located on reels 1, 3, and 5. In a poker game, the triggering event may be a pair of jacks or better. In other embodiments, the triggering event may be any winning outcome having a low or high probability. In those embodiments where a gaming machine presents both a primary game and a secondary game, the triggering event may be an outcome in either the primary or the secondary game. The primary game and/or the secondary game may be a video game or a mechanical game (e.g., a game having one or more reels or wheels). As those skilled in the art will appreciate, the triggering event may be any possible game outcome and does not necessarily have to be a winning outcome.

Additionally, triggering events may be based upon player activity/actions. For example, the triggering event may be based upon player performance such as, but not limited to, inserting a player tracking card into the gaming machine, time of play, frequency of play (i.e., number of games played in a particular period of time), number of maximum bets, number of player points earned, or a combination thereof. Additionally, a triggering event may be the player possessing a radio frequency identification (RFID) tag while playing a gaming machine. In these embodiments, a random performance characteristic may be selected to initiate the single-player-initiated, grouped bonus period. For example, the bonus period may be triggered when a player has continuously played the game for 30 minutes. Alternatively, achieving a predetermined performance threshold for a particular performance characteristic may be required to initiate the limited-time bonus period. For example, a bonus period may be initiated when a player has made twelve maximum bets. In another embodiment, the triggering event may be based upon the number of credits on the gaming machine. That is, a random or predetermined number of credits will trigger the bonus period. As those skilled in the art will appreciate, one or more of any of the disclosed triggering events may be required to initiate a single-player-initiated, grouped bonus period.

Generally, once a triggering has been established, a player initiates play of the secondary game. Alternatively, the secondary game is automatically started in response to the triggering event. As shown in FIG. 5A, one embodiment of a bonus game presented on a video display 20 that includes a plurality of symbols 60 that randomly move around the display. If a player presses a button (or touches the screen) when a symbol 60 appears in the middle of the screen and in-line with the reconfigurable pointer 16, the player is awarded the captured prize as shown in FIG. 5B. The reconfigurable pointer 16 may change colors to signify that the secondary game is active. In other embodiments, the pointer 16 flashes to signify that the bonus game is starting, ending, or in progress. In one embodiment, each of the symbols 60 has a credit value and/or a multiplier value. In another embodiment, the symbol 60 represents “free play” of the game or other game/outcome, game-enhancing features. In alternate embodiments, the symbol 60 may be associated with a tangible prize such as, but not limited to, show tickets, movie tickets, an automobile, a motorcycle, a boat, vacation packages, free casino rooms, free meals, services, or any combination thereof.

FIGS. 6A-6B illustrate another embodiment of a secondary game that may be presented on the video display 20 of the top box 12. As shown in FIG. 6A, an image of a split wheel 70 is shown on the video display 20. The upper portion of the wheel 72 includes numerical values, and the lower portion of the wheel 72 includes multiplier values or blank spaces. The reconfigurable pointer 16 is used to identify the numerical value and multiplier (if any) that will be awarded to the player when the wheels 72, 74 stop spinning. In one embodiment, the wheels 72, 74 spin in opposite directions as shown in FIG. 6B. In another embodiment, the upper and lower wheels 72, 74 rotate in the same direction when spun. The wheels 72, 74 may stop together or they may stop sequentially. For example, the upper wheel 72 stops prior to the lower wheel 74 (or vice versa).

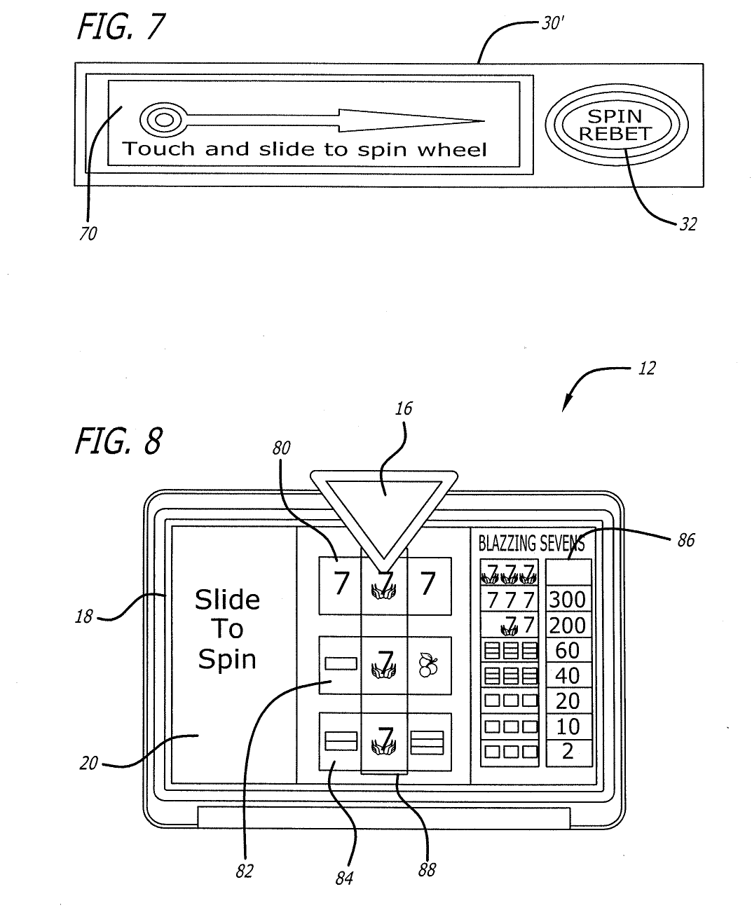

According to one embodiment, the wheels 72, 74 are spun when a player activates a “spin” button provided on a touch display provided on the top box 12. Alternatively, the wheels 72, 74 may be spun when a player actuates a virtual button or a mechanical button on the player interface. In another embodiment, the wheels 72, 74 are spun when the player touches and slides a finger across a touch display 76 as shown in FIG. 7. In one embodiment, the duration and/or length of the player's touch on the touch display 76 will determine the speed and duration of the spinning of the wheels. The touch display 76 may be provided on the player interface 30′ (as shown in FIG. 7) or on the touch screen associated with one or more video displays 20, 24.

FIG. 8 illustrates another embodiment of a secondary game that may be presented on the video display 20 of the top box 12. As shown in FIG. 8, video representations of three reels 80, 82, 84 are shown on the display 20. Optionally, a pay table 86 is presented next to the reels 80, 82, and 84. Like the secondary game described in FIGS. 6A-6B, the reels may be spun by a player activating a mechanical button, virtual button, or sliding a touch panel as shown in FIG. 7. As shown in FIG. 8, the reconfigurable pointer 16 identifies a pay line that spans across the reels 80, 82, and 84. FIG. 8 also shows that the pay line 88 is displayed, and a box 90 is drawn around the symbols that appear on the pay line. In alternate embodiments, only the reconfigurable pointer 16 may be used to identify the pay line 88. If an outcome as shown in the pay table 86 appears on the pay line 88 identified by the reconfigurable pointer 16, the player is awarded the prize amount as set forth in the pay table 86.

Referring back to FIG. 1, the main cabinet 14 of the gaming machine 10 is a self-standing unit that is generally rectangular in shape. In another embodiment, the main cabinet is a slant-top gaming cabinet. Alternatively, in other embodiments, the gaming cabinet may be a bar-top, table-top style cabinet, or any shaped cabinet known or developed in the art that is sized for a player to be able to sit or stand while playing a game. Additionally, the cabinet 14 may be manufactured with reinforced steel or other rigid materials that are resistant to tampering and vandalism. Optionally, in an alternate embodiment, the gaming machine 10 may instead be a cinema-style gaming machine (not shown), as disclosed in U.S. patent application Ser. No. 11/225,827, entitled “Ergonomic Gaming Cabinet,” filed on Sep. 12, 2005, which is hereby incorporated by reference.

As shown in FIG. 1, the gaming machine 10 includes a main display 24. According to one embodiment, the main display 24 is a plurality of mechanical reels for presenting a slot-style game. Alternatively, the main display 24 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 24 is a widescreen display (e.g., 16:9 or 16:10 aspect ratio display). In one embodiment, the display 24 is a flat-panel display including by way of example only, and not by way of limitation, liquid crystal, plasma, electroluminescent, vacuum fluorescent, field emission, LCOS (liquid crystal on silicon), and SXRD (Silicon Xtal Reflective Display), or any other type of panel display known or developed in the art. These flat-panel displays may use panel technologies to provide digital quality images including by way of example only, and not by way of limitation, EDTV, HDTV, or DLP (Digital Light Processing).

According to one embodiment, the widescreen display 24 may be mounted in the gaming cabinet 14 in a portrait or landscape orientation. In another embodiment, the game display 24 may also include a touch screen or touch glass system (not shown). The touch screen system allows a player to input choices without using any electromechanical buttons 32. Alternatively, the touch screen system may be a supplement to the electromechanical buttons 32.

The main cabinet 14 of the gaming machine also houses a game management unit (not shown) that includes a CPU 19, circuitry, and software for receiving signals from the player-activated buttons 32 and a handle (not shown), operating the games, and transmitting signals to the respective game display 32 and speakers (not shown). Additionally, the gaming machine includes an operating system such as Bally Gaming's Alpha OS, as disclosed in U.S. Pat. No. 7,278,068, which is hereby incorporated by reference.

In various embodiments, the game program may be stored in a memory (not shown) comprising a read-only memory (ROM), volatile or non-volatile random access memory (RAM), a hard drive or flash memory device or any of several alternative types of single or multiple memory devices or structures.

As shown in FIG. 1, the gaming machine 10 includes a plurality of player-activated buttons 32. These buttons 32 may be used for various functions such as, but not limited to, selecting a wager denomination, selecting a number of games to be played, selecting the wager amount per game, initiating a game, or cashing out money from the gaming machine 10. The buttons 32 function as input mechanisms. The buttons may be mechanical buttons, electromechanical buttons or touch screen buttons. Additionally, other input devices such as, but not limited to, a touch pad, a track ball, a mouse, switches, and toggle switches, are included with the gaming machine to also accept player input. Optionally, a handle (not shown) may be “pulled” by a player to initiate a slots-based game.

In another embodiment, one input mechanism is a universal button module that provides a dynamic button system adaptable for use with various games, as disclosed in U.S. patent application Ser. No. 11/106,212, entitled “Universal Button Module,” filed Apr. 14, 2005 and U.S. patent application Ser. No. 11/223,364, entitled “Universal Button Module,” filed Sep. 9, 2005, which are both hereby incorporated by reference.

In yet another embodiment, a virtual button deck may be provided on the player interface, as disclosed in U.S. patent application Ser. No. 11/938,203, entitled “Game Related Systems, Methods, and Articles that Combine Virtual and Physical Elements,” filed Nov. 9, 2007, which is hereby incorporated by reference.

FIG. 8 illustrates the internal components 17 of one embodiment of a gaming device 10. The components 17 comprise, for example, and not by way of limitation, software or data file components, firmware components, hardware components, or structural components of the gaming machine 10. These components include, without limitation, one or more processors 19, a hard disk device 21, volatile storage media such as random access memories (RAMs) 23, read-only memories (ROMs) 25 or electrically-erasable, programmable ROMs (EEPROMS) such as basic input/output systems (BIOS) 15. Additionally, the gaming device 10 includes a secured module 13. The secured module is a hardware component that is one-time programmable. One or more security algorithms may be provided on the secured module. The security algorithm generates a challenge (e.g., generates a random number), calculates an expected response to the challenge, and determines the validity of the BIOS based on the response to the challenge provided by the BIOS. In one embodiment, the secured module is a field-programmable gate array (FPGA). In another embodiment, the secured module is a trusted platform module (TPM).

In one embodiment, components 17 also include data files (which are any collections of data, including executable programs in binary or script form, and the information those programs operate upon), gaming machine cabinets (housings) 27, displays 20, 24, or compact disk, read-only memory (CDROM) or CD read-write (CD-RW) storage. In one embodiment, the data files may include data storage files, software program files, operating system files, and file allocation tables or structures. Ports 31 are be included with the gaming machine 10 for connection to diagnostic systems 33 and other input/output devices 35. In one embodiment, the ports 31 each comprise a serial port, universal serial bus (USB) port, parallel port or any other type of known port, including a wireless port. Preferably, each of the components 17 have embedded or loaded in them identification numbers or strings that can be accessed by the processor 19, including the processor 19 itself, which are utilized for authentication as explained below. In one embodiment, the components that are data files each use their file path and name as their identification number or string.

Either within the gaming machine 10, or in the diagnostic system 33 attachable to the gaming machine 10, are executable instructions or a software program 37 for authentication of the components (authentication software 37), which itself may be one of the components 17 to authenticate if it is internal to the gaming machine 10. In one embodiment, authentication software 37 is stored on a persistent storage media such as the hard disk device 21, ROM 25, EEPROM, in a complementary metal oxide semiconductor memory (CMOS) 39, in safe RAM comprising a battery-backed static random access memory (BBSRAM) 41, in one or more flash memory components 43, 45, or other types of persistent memory. In one embodiment, the authentication software 37 is stored in a basic input/output system (BIOS) 15 device or chip. BIOS chips 15 have been used for storing prior authentication software, such as previous versions of the BIOS+ chip used by Bally Gaming Systems, Inc. of Las Vegas, Nev. in their EVO gaming system. Placing the authentication software 37 in the BIOS 15 is advantageous because the code in the BIOS 15 is usually the first code executed upon boot or start-up of the gaming machine 10, making it hard to bypass the authentication process. Alternatively, in one embodiment, the authentication software 37 is stored in a firmware hub (FWH), such as Intel's 82802 FWH.

As an alternative, instead of, or in conjunction with, the hard disk device 21, another mass storage device is used, such as a CD-ROM, CD-RW device, a WORM device, a floppy disk device, a removable type of hard disk device, a ZIP disk device, a JAZZ disk device, a DVD device, a removable flash memory device, a hard card type of hard disk device, or solid state memory device.

In some embodiments, the gaming machine 10 is part of a gaming system connected to or with other gaming machines as well as other components such as, but not limited to, a Systems Management Server (SMS) and a loyalty club system (e.g., casino management personnel/system (CMP/CMS)). Typically, the CMP/CMS system performs casino player tracking and collects regular casino floor and player activity data. The gaming system may communicate and/or transfer data between or from the gaming machines 10 and other components (e.g., servers, databases, verification/authentication systems, and/or third party systems).

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

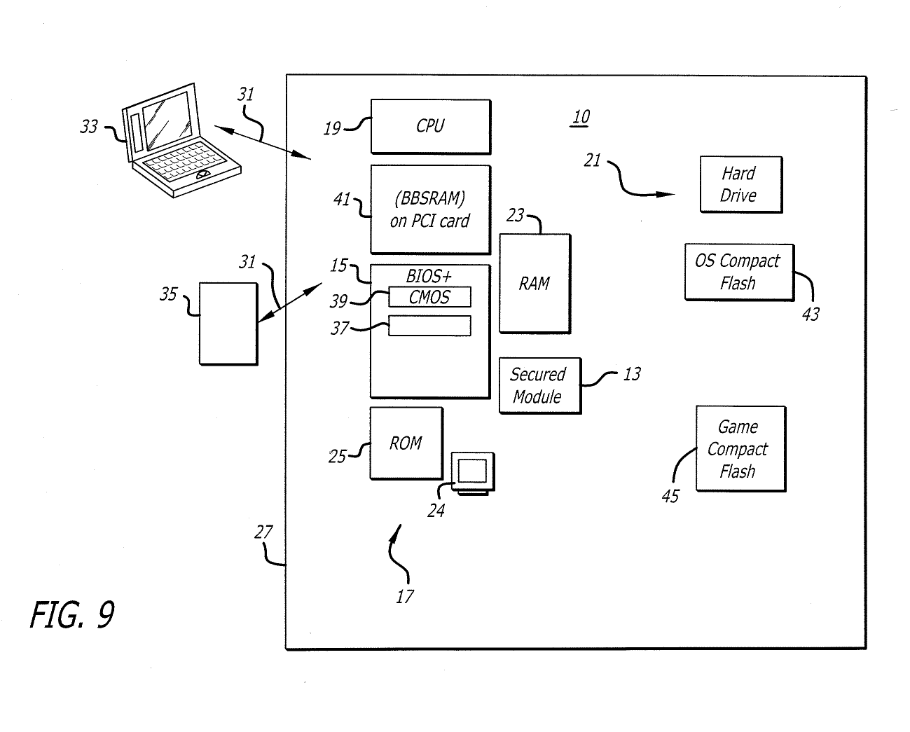

An embodiment of a network that may be used with the gaming device is illustrated in FIG. 9. The example network consists of a top-level vendor distribution point 300 that contains all packages for all jurisdictions, one or more jurisdiction distribution points 302 and 304 that contain regulator-approved, production-signed packages used within that jurisdiction or sub-jurisdiction, one or more Software Management Points 306 and 308 to schedule and control the downloading of packages to the gaming machine, and a one or more Software Distribution Points 310 and 312 that contain regulator-approved, production-signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 310, 312 or from the gaming servers.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming device, comprising:
a main display for presenting a primary game;
a top box having a video display, wherein the video display presents a secondary game when a triggering event has been established during play of the primary game;
one or more reconfigurable pointers positioned on the top box, wherein one or more reconfigurable pointers identify an outcome of the secondary game; and
a touch glass producing touch data when activated, wherein the touch data initiates play of the secondary game.

2. The gaming device of claim 1, further comprising a computer processing unit for determining whether a triggering event has been established in order to present a secondary game on the video display.

3. The gaming device of claim 1, further comprising a player interface for receiving player input.

4. The gaming device of claim 3, wherein the touch glass is positioned over the player interface.

5. The gaming device of claim 1, wherein the touch glass is positioned in front of the video display.

6. The gaming device of claim 1, wherein the secondary game comprises a first wheel adjacent to a second wheel, wherein the first wheel includes a plurality of credit values and the second wheel includes a plurality of multiplier values.

7. The gaming device of claim 1, wherein at least one of the one or more reconfigurable pointers includes a video display.

8. A method for presenting a bonus game in a top box of a gaming device, the top box having a video display and one or more reconfigurable pointers, the method comprising:
receiving player input initiating play of a game on a gaming device;
determining whether a trigger event is established during play of the game;
configuring one or more reconfigurable pointers in response to the trigger event being established;
displaying the bonus game on the video display in response to the trigger event being established;
receiving touch data from the player after the trigger event is established, wherein the touch data initiates play of the bonus game; and
identifying an outcome of the bonus game with one or more of the reconfigurable pointers.

9. The method of claim 8, wherein the bonus game comprises a first wheel adjacent to a second wheel, wherein the first wheel includes a plurality of credit values and the second wheel includes a plurality of multiplier values.

10. The method of claim 8, wherein the touch data causes the first wheel to rotate in a first direction and the second wheel to rotate in a second direction.

11. The method of claim 10, wherein the first direction and the second direction are the same.

12. The method of claim 10, wherein the first direction and the second direction are opposite directions.

13. The method of claim 7, wherein configuring one or more reconfigurable pointers further comprises selecting one or more of the reconfigurable to be active during play of the bonus game.
